(19) United States
(12) Patent Application Publication
(10) Pub. No.: US 2021/0306457 A1
(43) Pub. Date: Sep. 30, 2021

(54) METHOD AND APPARATUS FOR BEHAVIORAL ANALYSIS OF A CONVERSATION

(71) Applicant: Uniphore Software Systems, Inc., Palo Alto, CA (US)

(72) Inventor: Sekar KRISHNAN, Chennai (IN)

(21) Appl. No.: 16/836,892

(22) Filed: Mar. 31, 2020

(51) Int. Cl. H04M 3/493; H04M 3/42; H04M 3/51; G10L 25/63; G10L 15/26

(52) U.S. Cl. CPC H04M 3/4936; H04M 3/42382; G10L 15/265; G10L 25/63; H04M 3/5175

(57) ABSTRACT

A method and an apparatus for determining speaker behavior in a conversation in a call comprising an audio is provided. The apparatus includes a call analytics server comprising a processor and a memory, which performs the method. The method comprises receiving, at a call analytics server (CAS), a call audio comprising a speech of a first speaker, identifying an emotion based on the speech and identifying a sentiment based on a call text corresponding to the speech. Based on the identified emotion and sentiment, a behavior of the first speaker in the conversation is determined.

### FIELD

The present invention relates generally to improving call center computing and management systems, and particularly to behavioral analysis of a conversation.

### BACKGROUND

Several businesses need to provide support to its customers, which is provided by a customer care call center. Customers place a call to the call center, where customer service agents address and resolve customer issues.

Computerized call management systems are customarily used to assist in logging the calls and implementing resolution of customer issues.

An agent, who is a user of a computerized call management system, is required to capture the issues accurately and plan a resolution to the satisfaction of the customer. In many instances, overall customer satisfaction depends not only on the resolution, but also on how the agent interacts, particularly in response to the behavior of the customer. In fact, in some instances, the ability to arrive at a satisfactory resolution may depend on the agent's ability to decipher the customer's behavior correctly, and an appropriate response by the agent to such behavior.

Accordingly, there exists a need for techniques to analyzing the behavior of the speaking parties in a conversation.

### SUMMARY

The present invention provides a method and an apparatus for behavioral analysis of a conversation, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram depicting an apparatus for behavioral analysis of a conversation, in accordance with an embodiment of the present invention.

FIG. 2 is a flow diagram of a method for behavioral analysis of a conversation, for example, as performed by the apparatus of FIG. 1, in accordance with an embodiment of the present invention.

FIG. 3 depicts a comparison graph between the root mean square energy (RMSE) and time (in milliseconds) of wo different speeches, in accordance with an embodiment of the present invention.

### DETAILED DESCRIPTION

Embodiments of the present invention relate to a method and an apparatus for behavioral analysis of a conversation. Audio of a call is analyzed for detecting one or more emotions of a speaker (for example, a customer) on the call, and transcribed text of the call is analyzed for detecting one or more sentiments of the speaker. Based on the detected emotion(s) and sentiment(s), a behavior of the speaker is determined. The determined behavior can be shown to an agent speaking with the customer on the call, and additionally, a behavior can be recommended to the agent to appropriately converse with the customer. The techniques can be applied to live calls, and also be used for post-analysis of a call, where the behavior of the agent and the customer can be analyzed. The techniques may also be applied to scenarios other than that of call centers, for example, telephonic or conference calls, interview-interviewee calls, suspect and interrogator conversations, among several others.

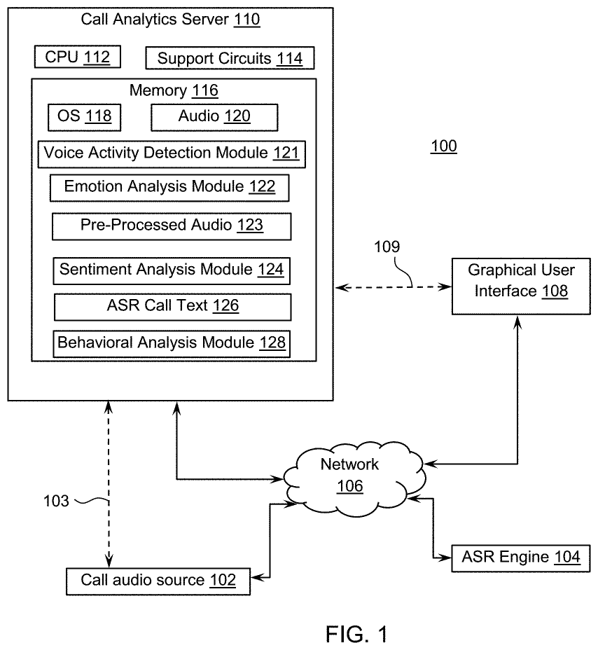

FIG. 1 is a schematic diagram an apparatus 100 for behavioral analysis of a conversation, in accordance with an embodiment of the present invention. The apparatus 100 comprises a call audio source 102, an ASR engine 104, a graphical user interface (GUI) 108, and a call analytics server (CAS) 110, each communicably coupled via a network 106. In some embodiments, the call audio source 102 is communicably coupled to the CAS 110 directly via a link 103, separate from the network 106, and may or may not be communicably coupled to the network 106. In some embodiments, the GUI 108 is communicably coupled to the CAS 110 directly via a link 109, separate from the network 106, and may or may not be communicably coupled to the network 106.

The call audio source 102 provides audio of a call to the CAS 110. In some embodiments, the call audio source 102 is a call center providing live audio of an ongoing call. In some embodiments, the call audio source 102 stores multiple call audios, for example, received from a call center.

The ASR engine 104 is any of the several commercially available or otherwise well-known ASR engines, providing ASR as a service from a cloud-based server, or an ASR engine which can be developed using known techniques. ASR engines are capable of transcribing speech data to corresponding text data using automatic speech recognition (ASR) techniques as generally known in the art.

The network 106 is a communication network, such as any of the several communication networks known in the art, and for example a packet data switching network such as the Internet, a proprietary network, a wireless GSM network, among others. The network 106 communicates data to and from the call audio source 102 (if connected), the ASR engine 104, the GUI 108 and the CAS 110.

The GUI 108 is an interface available to an agent of the call center, for example the agent speaking to a customer on the call. The GUI 108 may be a part of a digital computing device such as a computer, server, tablet, smartphone or other similar devices, accessible to the agent or a user to who the behavior analysis needs to be displayed.

The CAS server 110 includes a CPU 112 communicatively coupled to support circuits 114 and a memory 116. The CPU 112 may be any commercially available processor, microprocessor, microcontroller, and the like. The support circuits 114 comprise well-known circuits that provide functionality to the CPU 112, such as, a user interface, clock circuits, network communications, cache, power supplies, I/O circuits, and the like. The memory 116 is any form of digital storage used for storing data and executable software. Such memory includes, but is not limited to, random access memory, read only memory, disk storage, optical storage, and the like.

The memory 116 includes computer readable instructions corresponding to an operating system (OS) 118, an audio 120 (for example, received from the call audio source 102), a voice activity detection (VAD) module 121, a pre-processed audio 123, an emotion analysis module 122, a sentiment analysis module, an ASR call text 126, and a behavior analysis module 128.

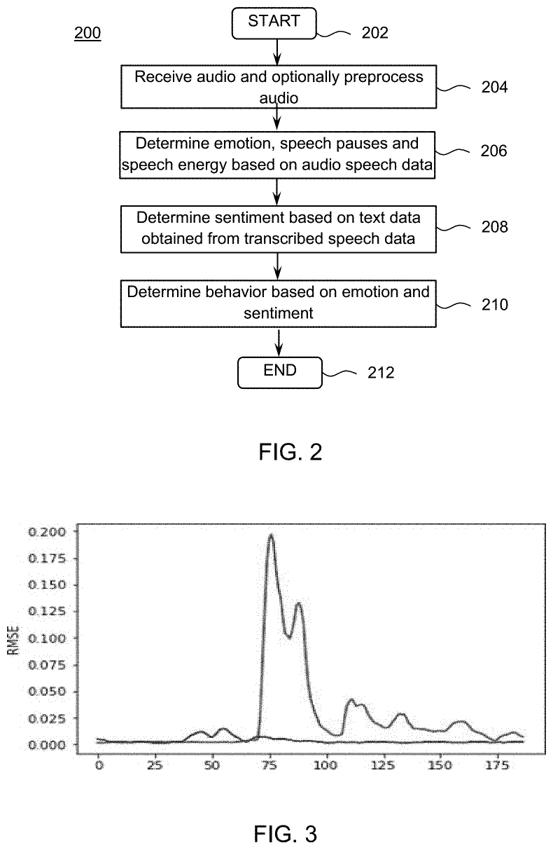

According to some embodiments, behavior analysis according to the embodiments described herein is performed in near real-time, that is, as soon as practicable. In such embodiments, while a call is under progress between a customer and an agent, audio of the call of any duration is sent (for example, from a call center) to the CAS 110 in near real-time. In some embodiments in a near real-time scenario, the audio of the call is sent in chunks of about 5 seconds to about 12 seconds duration, and is processed according to techniques described herein with respect to FIG. 2. The audio of the call is stored on the CAS 110 as the audio 120.

According to some embodiments, behavior analysis according to the embodiments described herein is performed later than near real-time, for example, after introducing a delay in processing the call, or at a time after a call is concluded. In such embodiments, the audio of the call is sent to the CAS 110 in near real-time, buffered in chunks of predefined duration, for example, 30 seconds, or after the call is concluded. The audio of the call is stored on the CAS 110 as the audio 120.

According to some embodiments, the VAD module 121 generates the pre-processed audio 123 by removing non-speech portions from the audio 120. The non-speech portions include, without limitation, beeps, rings, silence, noise, music, among others. Upon removal of the non-speech portion, the VAD module 121 sends the pre-processed audio 123 to an ASR engine, for example, the ASR engine 104, over the network 106. According to some embodiments, the pre-processed audio 123 is diarized, either by virtue of the audio 120 being diarized, or by processing the audio 120 or the pre-processed audio 123 using speaker diarization techniques, as known in the art.

The emotion analysis module 122 processes the pre-processed audio 123 to identify various features related to emotions associated with the speech. In some embodiments, the emotion analysis module 122 splits the pre-processed audio 123 into chunks of 5 seconds each. The emotion analysis module 122 determines features directly related to emotions, such as the pitch and the harmonics and/or cross-harmonics of the speech of a person. The emotion analysis module 122 also determines speech acoustics features, such as pauses in speech, speech energy, and mel frequency cepstral (MFC) coefficients for the pre-processed audio 123. Based on the pitch, the harmonics and/or cross-harmonics, and the speech acoustic features, the emotion analysis module 122 determines an emotion (for example, happy, sad, frustrated, angry, and neutral) corresponding to the speech. In some embodiments, the emotion analysis module 122 identifies and accommodates cadence of speech to accommodate for demographics. For example, speech of an old lady from Texas, USA may require a very different processing compared to a young man from Tamil Nadu, India. In some embodiments, an artificial intelligence (AI) and/or machine learning (ML) model, such as random forest (RF) or extreme gradient boosting algorithm, may be trained based on the pitch, the harmonics (and/or cross-harmonics, speech pauses, speech energy, MFC coefficient, or cadence, among several others. In some embodiments,

The ASR engine 104 processes the call audio 120, for example, received from the CAS 110 or received directly from the call audio source 102. The ASR engine 104 transcribes the call audio 120 and generates text corresponding to the speech in the call audio 120, and sends the text to the CAS 110, for example, over the network 106. According to some embodiments, the transcription of the call audio 120 is implemented in near real-time, that is, as soon as practicable. The text is stored on the CAS 110 as the ASR call text 126. According to some embodiments, the ASR engine 104 processes the pre-processed audio 123, from which the non-speech portions have been removed. The transcription of the pre-processed audio by the ASR engine 104 is more efficient than the conventional solutions because only speech portions of the audio need to be processed, and because the total time of the audio, and therefore, the audio processing, is reduced. The ASR engine 104 transcribes the pre-processed audio 123 and generates the ASR call text 126 corresponding to the speech in the pre-processed audio 123, and sends the ASR call text 126 to the CAS 110, for example, over the network 106. The ASR call text 126 includes time stamps to match text corresponding to a portion of the speech.

The sentiment analysis module 124 processes the ASR call text 126 to identify one or more sentiments from the text corresponding to the same portion of the call for which emotions are identified, for example, by the emotion analysis module 122. In some embodiments, the sentiment analysis module 124 processes the ASR call text 126 in near real time, that is, as soon as practicable. The identified sentiments include strongly positive, positive, mildly positive, neutral, mildly negative, negative, and strongly negative.

The behavioral analysis module 128 analyzes the identified emotion(s) and the sentiment(s) to determine one or more behavior of the customer on the call. In some embodiments, a determined emotion and a determined sentiment are used to predict a behavior of the customer. The behaviors determined by the behavior analysis module 128 include polite, impolite, friendly, rude, empathetic and neutral. In some embodiments, based on the determined behavior of a customer, the behavior analysis module 128 generates a recommendation for a behavior to be adopted by an agent speaking to the customer. Such a recommended behavior is displayed to the agent via the GUI 108. In response to viewing the recommended behavior, the agent may choose to follow the recommendation, or decide to adopt another behavior. In some embodiments, a conversation is analyzed after the conversation has concluded, and the behaviors of the customer (or a first speaker) and/or the agent (or a second speaker) are tracked through different portions of the conversation.

FIG. 2 is a flow diagram of a method 200 for behavioral analysis of a conversation, for example, as performed by the apparatus 100 of FIG. 1, in accordance with an embodiment of the present invention. According to some embodiments, the method 200 is performed by the various modules executed on the CAS 110. The method 200 starts at step 202, and proceeds to step 204, at which the method 200 receives an audio, for example, the audio 120, and preprocesses the audio 120. For example, the audio 120 comprises a speech excerpt of a customer in a conversation with an agent over a telephonic call. The audio 120 is recorded in near real-time on the CAS 110 from a live call in a call center, for example, a call center or a call audio source 102. In some embodiments, the audio 120 is a pre-recorded audio received from an external device such as the call audio source 102.

In some embodiments, at step 204, the audio 120 is preprocessed, for example, by the VAD module 121 of FIG. 1, to remove non-speech portions, and yield the pre-processed audio 123. The VAD module 121 has four sub-modules, Beep & Ring Elimination module, Silence Elimination module, Standalone Noise Elimination module and Music Elimination module. Beep & Ring Elimination module analyzes discrete portions (e.g., each 450 ms) of the call audio for a specific frequency range, because beeps and rings have a defined frequency range according to the geography. Silence Elimination module analyzes discrete portions (e.g., each 10 ms) of the audio and calculates Zero-Crossing rate and Short-Term Energy to detect silence. Standalone Noise Elimination module detects standalone noise based on the Spectral Flatness Measure value calculated over a discrete portion (e.g., a window of size 176 ms). Music Elimination module detects music based on “Null Zero Crossing” rate on discrete portions (e.g., 500 ms) of audio chunks. Further, the VAD module 121 also captures output offset due to removal of non-speech portions. For example, the VAD module 121 may generate a chronological data set of speech and non-speech portions indexed using the milliseconds pointer [(0, 650, Non-Speech), (650, 2300, Speech), (2300, 4000, Non-Speech), (4000, 8450, Speech), . . . ].

The method 200 proceeds to step 206, at which the method 200 determines an emotion based on the speech in the audio 120 or audio 123. In some embodiments, step 206 is performed by the emotion analysis module 122. In some embodiments, the method 200 also determines speech pauses and/or speech energy at step 206.

In embodiments in which the behavior analysis is performed in near real-time, the pre-processed audio 123 is processed as is, that is in a chunk size of duration in which it is received after being pre-processed, for example by the VAD module 121. In embodiments in which the behavior analysis is not performed in near real-time, the emotion analysis module 122 divides the pre-processed audio 123 into chunks of a predefined duration. For example, the chunks have a duration between about 3 seconds to about 5 seconds, and in some cases, the pre-processed audio 123 is divided to comprises chunks of 5 seconds.

Each chunk is individually processed to determine features directly related to emotions, such as pitch and harmonics and/or cross-harmonics. Wave forms produced by our vocal cords, which govern the pitch, change depending on emotions. Further, in heightened emotional states, for example, anger or stress, additional excitation signals other than pitch, such as harmonics and cross-harmonics, can also be discerned from the wave forms.

In addition, each chunk is processed to determine speech acoustics features, for example, pauses in speech, speech energy, and MFC coefficients. Pauses in speech refer to the pauses in between words, or phrases or sentences. Such pauses are different from portions comprising silence, for example, those removed by the VAD module 121. A pause is typically between about 30 milliseconds to about 200 milliseconds, while silence is usually more than this duration. The duration of pauses in speech are also related to emotions. For example, very fast speech is marked by short pauses, and represents an excited state, which is associated with emotions such as anger or happiness. On the other hand, emotions such as sad would be characterized by slow speech, and marked by long pauses. Speech pause count (measured in time, e.g., 5 ms) are used to determine the rate of speech, and emotion. In some embodiments, standard rate of speech guideline for normal range is 140-160 words of speech per minute (wpm), a count higher than 160 wpm is considered to be a high rate of speech, while a count of less than 140 wpm is considered a low rate of speech. According to some embodiments, the pause is speaker dependent, and the range for normal, high or low rate of speech are adjusted accordingly, via an input, auto detection and normalization, among other techniques.

In many instances, energy of a speech signal is related to its loudness, which is usable to detect certain emotions. FIG. 3 depicts a comparison graph 300 between the root mean square energy (RMSE) and time (in milliseconds) of wo different speeches. The graph 300 shows an energy level plot 310 of an “angry” signal, and an energy level plot 320 of a “sad” signal. RMSE is calculated frame by frame and both the average and standard deviation are considered pertinent features. The RMSE numerical values are compared to a threshold number or a range, where a value smaller than the threshold implies low energy, whereas a value higher than the threshold implies high energy.

Mel-frequency cepstral (MFC) coefficients or MFCC are derived from a type of cepstral representation of the audio clip, for example, a nonlinear spectrum-of a spectrum, using techniques generally known in the art. The MFC coefficients represent the amplitudes of the resulting spectrum.

The emotion analysis module 122 determines, for each chunk, the features directly related to emotions, such as pitch and harmonics and/or cross-harmonics, and the speech acoustics features, such as speech pauses (or rate of speech), speech energy and MFC coefficients. Based on the above features, the emotions analysis module 122 determines one or more emotions, happy, sad, frustrated, angry, and neutral, for example, using known techniques.

The method 200 proceeds to step 208, at which the method 200 determines a sentiment based on the transcribed speech of the audio 120 or the pre-processed audio 123, for example, the ASR call text 126 received from an ASR engine, such as the ASR engine 104. In some embodiments, the chunks of speech audio created by the emotion analysis module 122 are transcribed, and such chunks include timestamps according to the audio 120. In some embodiments, step 208 is performed by the sentiment analysis module 124.

According to some embodiments, text data is tokenized, that is, extracted from the transcript and split into individual words. Next, words which do not carry any meaning, referred to as “stop words” are removed. Non-limiting examples of stop words include “a,” “an,” “the,” “they,” “while,” among several others that would occur to those of ordinary skill. Next, and optionally, the punctuations are removed. The text processed in this manner is then compared with a predefined sentiment lexicon to yield a score corresponding to an inferred sentiment.

Each word is scored with their sentiment weightage or corresponding intensity measure based on a predefined Valence Aware Dictionary and Sentiment Reasoner (VADER). VADER calculates the sentiment from the semantic orientation of word or phrases that occur in a text. For example, VADER accommodates for difference between the words “good,” “great” and “amazing,” and the differences are represented by the intensity score assigned to a given word. Additionally, VADER assigns weightage to polarity, subjectivity, objectivity and context of each word. As an example, the VADER or the predefined sentiment lexicon is designed to assign scores as follows: −3 to −4 to “extremely negative,”−1 to −3 to “negative,” 0 to −1 to “mildly negative,” 3 to 4″ to “extremely positive,” 1 to 3 to “positive,” 0 to 1 to “mildly positive,” and 0 for “neutral” or indeterminable words.

The sentiment lexicon or VADER has or assigns words with corresponding sentiment weightage scores. Words associated with negative sentiments are assigned negative scores, and words associated with positive sentiments are assigned positive scores. The quantum of the scores are assigned according to the intensity of the sentiment represented by a word.

For example, the word “good” may be assigned a score of +1.9, and the word “bad” may be assigned a score of −2.5. In this manner, the sentiment scores assigned to each word are used to calculate an average score for a sentence. For example, in the sentence “I am Good,” the words “I” and “am” may be considered as stop words or removed, or have sentiment score of 0, each. Therefore, the sentiment score for the sentence would be 0+0+1.9=+1.9.

In another example, the sentiment detection module 124 determines the sentiment for a sentence “Sekar is a great man,” as follows. The sentence text is first tokenized to yield individual words: “Sekar,” “is,” “a,” “great,” “man.” Next, stop words are identified as “is,” “a,” and removed from the evaluation, leaving “Sekar,” “great,” “man.” Next, the remaining text is scored against a sentiment lexicon as discussed above, or a sentiment lexicon system such as VADER, which would score the words as follows: “Sekar”—0; “great”—3.1; “man”—0, providing a total score of 3.1, which would correspond to a “strongly positive” sentiment based on, for example, the sentiment lexicon discussed earlier.

The method 200 proceeds to step 210, at which the method 200 determines, based on the emotion, the speech pause and the speech energy identified at step 206, and the sentiment identified at step 208, a behavior of the speaker to whom the speech of the audio 120 or the audio 123 (and the text in ASR text 126) corresponds. In some embodiments, step 210 is performed by the behavioral analysis module 128.

The behavioral analysis module 128 determines the rate of speech based on the speech pauses. A normal rate of speech typically includes between 140-160 spoken words per minute (wpm), although other ranges may be defined. A measure of the speech pauses is used to calculate the percentage of pause in a person's speech. For a given chunk or chunks of audio, percentage of the speech pause in such chunk or chunks is determined, and according to predefined ranges, the speech in such chunks is determined to be normal, slow or fast. According to some embodiments, speech is determined to be normal if the percentage of time the speech is paused is between about 20 and about 50 percent. The speech is determined to be fast if the speech pauses are less than about 20 percent, and the speech is determined to be slow if the speech pauses are more than about 50 percent.

Further, the behavioral analysis module 128 determines energy level based on the RMSE values. According to some embodiments, RMSE values of between about 0.05 to about 0.10 are determined to be normal, more than about 0.10 are determined to be high, and less than about 0.05 are determined to be low. If the speech energy is determined to be high, and the rate of speech is determined to be high, the behavioral analysis module 128 further determines that the speaker is in an excited state. In all other instances, the behavioral analysis module 128 determines the speaker is not in an excited state.

The behavioral analysis module 128 determines (see Table 1) an interim behavior (C) of a speaker based on the emotion (A) determined by the emotion analysis module 122 and the sentiment (B) determined by the sentiment analysis module 124. Next, the behavioral analysis module 128 determines the speaker behavior (D) based on the determined interim behavior (C) and the sentiment (B) determined by the sentiment analysis module 124.

TABLE 1

| | | Interim | Speaker |
|---|---|---|---|
| Emotion (A) | Sentiment (B) | Behavior (C) | Behavior (D) |
| Happy | Strongly Positive | Happiness | Friendly |
| Happy | Strongly Negative | Angry | Rude |
| Happy | Positive | Happiness | Friendly |
| Happy | Negative | Frustrated | Impolite |
| Happy | Neutral | Happiness | Neutral |
| Happy | Mildly Positive | Happiness | Polite |
| Happy | Mildly Negative | Happiness | Neutral |
| Anger | Strongly Positive | Happiness | Friendly |
| Anger | Strongly Negative | Angry | Rude |
| Anger | Positive | Happiness | Friendly |
| Anger | Negative | Angry | Rude |
| Anger | Neutral | Frustrated | Impolite |
| Anger | Mildly Positive | Frustrated | Impolite |
| Anger | Mildly Negative | Frustrated | Impolite |
| Sadness | Strongly Positive | Neutral | Polite |
| Sadness | Strongly Negative | Sadness | Empathy |
| Sadness | Positive | Normal | Polite |
| Sadness | Negative | Sadness | Empathy |
| Sadness | Normal | Normal | Normal |
| Sadness | Mildly Positive | Normal | Polite |
| Sadness | Mildly Negative | Sadness | Empathy |
| Normal | Strongly Positive | Happiness | Friendly |
| Normal | Strongly Negative | Frustrated | Normal |
| Normal | Positive | Normal | Polite |
| Normal | Negative | Normal | Normal |
| Normal | Normal | Normal | Normal |
| Normal | Mildly Positive | Normal | Polite |
| Normal | Mildly Negative | Normal | Normal |
| Frustrated | Strongly Positive | Happiness | Friendly |
| Frustrated | Strongly Negative | Angry | Rude |
| Frustrated | Positive | Normal | Normal |
| Frustrated | Negative | Frustrated | Impolite |
| Frustrated | Normal | Normal | Normal |
| Frustrated | Mildly Positive | Normal | Normal |
| Frustrated | Mildly Negative | Frustrated | Impolite |

In this manner, the behavioral analysis module 128 determines the speaker behavior for chunk or chunks of speech, for example, extracted from the pre-processed audio 123 or the audio 120.

In some embodiments, the method 200 performs an optional step (not shown in FIG. 2) in which the method 200 recommends a behavior to the agent in response to determined behavior of the customer. For example, the behavioral analysis module 128 generates a behavioral recommendation for the agent, which is communicated (e.g. via visual or audible prompts) to the agent via the GUI 108. In some embodiments, the method 200 performs an optional step (not shown in FIG. 2), in which the method 200 analyzes the behavior of the agent, the customer, or both, and provides an evaluation of the agent's behavior.

The method 200 proceeds to step 212, at which the method 200 ends.

In some embodiments, the method 200 is performed in near real-time, that is, as soon as practicable given the constraints of the apparatus. While the techniques described hereinabove perform the behavioral analysis in near real time, part or entirety of such techniques may be used for behavioral analysis passively, that is, at a time after the call. Further, while the techniques described hereinabove perform a behavioral analysis of the customer, the same techniques can be used to identify the behavior of the agent. For example, the behavior of the agent can be determined to be from one or more of lazy, friendly, polite, rude, or normal. While the techniques of steps 206, 208 and 210 have been described with respect to a pre-processed audio 123 for efficiency, the techniques may be applied directly to the audio 120. While specific ranges for speech pauses, speech energy, sentiment scores and other parameters have been used, such ranges are not limiting to the techniques herein, rather used to illustrate the use of the techniques herein. The ranges may be modified according to the application of such techniques.

In some embodiments, all speech and acoustics features, such as, pitch, harmonics, pause, MFC coefficients, and the like are calculated from speech chunk, and used to determine the emotion. Additionally, the behavior analysis module 128 uses the already known rate of speech (based on speech pauses), and speaker energy (based on calculated RMSE). In some embodiments, such features and the excitation state are used to determine emotion, and in some embodiments, such features are trained with an Artificial Intelligence/Machine Learning algorithm.

The described embodiments enable a superior identification of the behavior of a customer in a conversation with an agent, and such identification is instrumental in improving the experience of the customer when speaking to the agent, and overall customer satisfaction.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are illustrated in the context of specific illustrative configurations. Finally, structures and functionality presented as discrete components in the example configurations may be implemented as a combined structure or component. These and other variations, modifications, additions, and improvements may fall within the scope of embodiments as described.

While the foregoing is directed to embodiments of the present invention, other and further embodiments of the invention may be devised without departing from the basic scope thereof.

1. A method for determining speaker behavior in a conversation in a call comprising an audio, the method comprising:
receiving, at a call analytics server (CAS), a call audio comprising a speech of a first speaker;
identifying, at the CAS, an emotion based on the speech;
identifying, at the CAS, a sentiment based on a call text, the call text corresponding to the speech; and
determining a behavior of the first speaker in the conversation based on the emotion and the sentiment.

2. The method of claim 1, wherein the call text is received at the CAS from an automatic speech recognition (ASR) engine.

3. The method of claim 1, wherein the call audio is received at the CAS in near real time, and the call text is received at the CAS near real time.

4. The method of claim 1, wherein the emotion comprises at least one of happy, anger, frustration, sad or neutral,
wherein the sentiment comprises at least one of positive; strongly positive, mildly positive, negative, strongly negative, mildly negative, or neutral, and
wherein the behaviour comprises at least one of polite, impolite, friendly, rude, empathetic and neutral,
wherein the determining the behavior comprises identifying a pair comprising the emotion and the sentiment, and optionally, rate of speech, speaker energy and excitement state of the speaker.

5. The method of claim 4, further comprising recommending a behavior for a second speaker in the audio, in response to the determined behavior of the first speaker.

6. An apparatus for determining speaker behavior in a conversation in a call comprising an audio, the apparatus comprising:
a processor; and
a memory communicably coupled to the processor, wherein the memory comprises computer-executable instructions, which when executed using the processor, perform a method comprising:
receiving, at a call analytics server (CAS), a call audio comprising a speech of a first speaker,
identifying, at the CAS, emotion based on the speech,
identifying, at the CAS, sentiment based on a call text, the call text corresponding to the speech, and
determining a behavior of the first speaker in the conversation based on the emotion and the sentiment.

7. The apparatus of claim 6, wherein the call text is received at the CAS from an automatic speech recognition (ASR) engine.

8. The apparatus of claim 6, wherein the call audio is received at the CAS in near real time, and the call text is received at the CAS near real time.

9. The apparatus of claim 6, wherein the emotion comprises at least one of happy, anger, frustration, sad or neutral,
wherein the sentiment comprises at least one of positive, strongly positive, mildly positive, negative, strongly negative, mildly negative, or neutral, and
wherein the behaviour comprises at least one of polite, impolite, friendly, rude, empathetic and neutral,
wherein the determining the behavior comprises identifying a pair comprising the emotion and the sentiment, and optionally, rate of speech, speaker energy and excitement state of the speaker.

10. The apparatus of claim 9, wherein the method further comprises recommending a behavior for a second speaker in the audio, in response to the determined behavior of the first speaker.
